(19) United States
(12) Patent Application Publication
(10) Pub. No.: US 2026/0116344 A1
(43) Pub. Date: Apr. 30, 2026

(54) Method for detecting at least one deposit, in particular dirt, on a window surface of a motor vehicle

(71) Applicant: HELLA GmbH & Co. KGaA, Lippstadt (DE)

(72) Inventors: Thomas Niemann, Delmenhorst (DE); Dirk Jegminat, Bremen (DE)

(21) Appl. No.: 19/370,205

(22) Filed: Oct. 27, 2025

(30) Foreign Application Priority Data
Oct. 25, 2024 (DE) 102024131255.6

(51) Int. Cl. B60S 1/08

(52) U.S. Cl. CPC B60S 1/0848; B60S 1/0874

(57) ABSTRACT

A sensor assembly having a radiation receiver and a radiation emitter, and a windscreen wiping device are assigned to the window surface of the motor vehicle. The radiation emitter emits a radiation signal to the window surface and reflected on a boundary surface with the environment surrounding the vehicle. A radiation measurement value of the reflected radiation signal is detected by the radiation receiver. When an increased amount of reflected radiation is detected, this indicates a deposit on the window surface, and the windscreen wiping device is initiated to wipe the window surface. A further radiation measurement value of the reflected radiation is detected after wiping with the windscreen wiping device. The radiation measurement value detected after wiping is compared with the radiation measurement value detected before wiping. If the difference between the radiation measurement values before and after wiping is small enough, it indicates dirt on the window surface.

### BACKGROUND OF THE INVENTION

### Field of the Invention

The invention relates to a method for detecting at least a dirt deposit on a window surface of a motor vehicle, wherein at least one sensor assembly is assigned to the window surface of the motor vehicle.

### Brief Summary of the Related Art

Many motor vehicles are equipped with camera systems, which are intended to improve driving safety, for example. Particularly in the case of autonomous vehicles, camera systems are very important for sensing the vehicle's surroundings. Accordingly, it is imperative that the camera systems are able to function faultlessly. Camera systems are usually arranged inside the motor vehicle, behind window surfaces, for example behind the front windscreen and/or the rear windscreen. Dirt deposits on the windscreen or rear windscreen in the camera's field of view can adversely affect the camera's ability to detect the surrounding environment. Detection of the dirt by the camera itself is difficult, because the cameras are designed to focus a long way in front of the vehicle. Dirt in the field of view on a window surface immediately in front of the camera cannot be detected reliably.

### SUMMARY OF THE INVENTION

The object underlying the invention is to suggest a method for detecting deposits on a window surface of a motor vehicle, wherein a sensor system intended specifically for the purpose is not needed to implement the method.

This object is solved with a method having the features of the independent claim. Further developments and advantageous variants are presented in the subordinate claims.

According to the invention, a method for detecting at least a dirt deposit on a window surface of a motor vehicle is suggested, wherein at least one sensor assembly, in particular a rain sensor, having at least one radiation receiver and having at least one radiation emitter, is assigned to the window surface of the motor vehicle, wherein at least one windscreen wiping device is also assigned to the window surface to wipe at least a section of the window surface, and wherein the radiation receiver of the sensor assembly is arranged in the wipe area of the windscreen wiping device, wherein the radiation emitter is designed to emit at least one radiation signal, wherein the radiation signal is coupled into the window surface and reflected therein on a boundary surface with the environment surrounding the vehicle, and wherein a radiation measurement value of the reflected radiation signal is detected by means of the radiation receiver, wherein when an increased amount of reflected radiation is coupled out of the window surface, this is interpreted to indicate a deposit on the window surface, and wherein wiping of the window surface by the windscreen wiping device is initiated, wherein a further radiation measurement value of the reflected radiation is detected after wiping with the windscreen wiping device, wherein the radiation measurement value of reflected radiation recorded after wiping is compared with the radiation measurement value of reflected radiation detected before wiping, and wherein if the difference between the radiation measurement values before and after wiping is small enough, it is interpreted to indicate that there is dirt on the window surface.

Optical sensors are provided in the area of the window surfaces in many motor vehicles for sensing surrounding conditions. For example, a rain sensor or also a rain-light sensor may be provided, with which the rain collecting on the window surfaces can be detected. A rain-light sensor is an optical sensor that includes at least one radiation receiver and one radiation emitter. With the radiation emitter, radiation can be coupled into the windscreen and reflected therein. In particular, reflections take place inside the window surface at the boundary surface between the window surface and the surrounding environment and at the boundary surface with the interior of the motor vehicle. The reflections inside the window surface form a measurement path. The amount of radiation that is coupled out of the windscreen again after the measurement path may be detected by means of the radiation receiver. The radiation measurement value may be the radiation intensity, for example. Rain or other deposits on the outside of the window surface in the region of the measurement path cause more of the radiation to be coupled out of the window surface, thereby decreasing the amount of reflected radiation. A reduction in the amount of radiation reflected inside the window surface may be interpreted as the presence of rain or another deposit on the window surface. The window surfaces of motor vehicles are equipped with windscreen wiping devices, that is to say windscreen wipers, with which a wipe area of the window surface can be wiped to remove rain or other deposits. The windscreen wiping device serves to clean and dry the wipe area. The radiation receiver of the sensor assembly is arranged in the wipe area of the windscreen wiping device. When it is detected that an increased amount of the radiation coupled into the window pane is being coupled out of the window surface, wiping the window surface with the windscreen wiping device may be initiated. After the window surface has been wiped, a radiation measurement value of the radiation reflected in the window surface is recorded again. This new recording of a radiation measurement value is compared with the radiation measurement value that was recorded before wiping. If the difference between the radiation measurement values is small enough, that is to say if the radiation measurement values are substantially the same, this may be interpreted to mean that there is a deposit in the form of dirt on the window surface. If the deposit were rain, it should have been removed after wiping and coupling out of the windowpane would have decreased again after wiping. If approximately the same radiation measurement values are sensed before and after the wiping, cleaning of the window surface with the vehicle's window washing system may be initiated to clear the camera's field of view. Thus, if there is dirt on the window surface, the window surface may be wiped by the windscreen wiper in the dry state. However, if dirt is present, cleaning with the window washing system is initiated immediately after wiping in the dry state as well, so dry wiping is not perceived as objectionable. By this method, it is possible to detect the presence of dirt on the window surface without the need to provide a sensor system specifically for this purpose.

### DETAILED DESCRIPTION OF THE PREFERRED EMBODIMENTS

In a preferred embodiment of the invention, if the difference between the radiation measurement values of the reflected radiation before and after wiping falls below a predetermined threshold value, this is interpreted to indicate that there is dirt on the window surface. A threshold value for the difference between the radiation measurement values before and after wiping may be defined and specified in advance. If the difference falls below the threshold value, that is to say the coupling out has not decreased by a large enough amount after wiping, with the result that the radiation measurement values before and after wiping are approximately the same, it is concluded that there is dirt on the window surface that cannot be removed simply by wiping with the windscreen wiper.

In a preferred embodiment of the invention, maximum values for the radiation measurement values of the reflected radiation are detected, at least one filtered maximum value is formed from the maximum values for the radiation measurement values, and the radiation measurement value detected after wiping is evaluated on the basis of the filtered maximum value of the radiation measurement values. In the case of a clear window, the signal strength of the reflected radiation signal should return to the original maximum value again after the wiping operation. But if deposits such as dirt, salt or wiping streaks are left behind, the signal strength does not rise fully back up to the maximum value. This reduced radiation measurement value may be interpreted as dirt. However, determination of a radiation measurement value immediately after wiping can be inaccurate and/or unstable. For example, inaccuracies may be caused by drying residual moisture, the movement of droplets or the like, which cause the radiation to be coupled out of the window pane. This may influence a decision regarding the degree of soiling immediately after wiping. To enable a better evaluation to be made, maximum values for the reflected radiation are determined over a period of time, for example over a time interval of seconds to minutes, and a filtered maximum value is calculated from these. Influencing factors such as rain, light conditions or overwipes are filtered out when the filtered maximum value is formed. The filtered maximum value may be a moving average value that reflects the trend, whether the glass is rather clean or rather dirty. A function my be derived empirically from the collected long-term data, which function evaluates and corrects the resilience of the radiation measurement values that are captured immediately after wiping. This enables more reliable detection of dirt and improved assignment of the degree of dirt.

In a further development of the method, further radiation measurement values are captured by means of at least one further sensor assembly, which is designed to detect at least one radiation signal that passes through the window surface, the further radiation measurement values are recorded at time intervals, the further radiation measurement values are analysed statistically, and if it is determined that the further radiation measurement values are generally decreasing over time, they are used to carry out a plausibility check of a detected dirt deposit.

The at least one further sensor assembly of the motor vehicle may be for example an ambient light sensor, with which the ambient light conditions around the motor vehicle are detected. Depending on the vehicle, other optical sensors for receiving radiation may be provided, such as a sensor linked to a head-up display. The radiation measurement value may be in particular a radiation intensity measurement value. The radiation that passes through the window surface is detected and analysed statistically at time intervals. In particular, a trending decrease in the detected radiation measurement values over time may suggest the presence of dirt on the window surface, since the radiation is attenuated by the dirt as it passes through the window surface. Through the statistical analysis, in particular analysis of the radiation intensity over time, the measurement values may be used to test the plausibility of suspected dirt on the window surface despite the fluctuations in the current radiation measurement values, which are decisive for ambient light intensity, for example. For example, if the presence of dirt is suspected on the basis of the radiation measurement values recorded with a rain sensor before and after wiping, this can be confirmed, that is to say its plausibility can be tested by statistical analysis of the ambient light measurement values.

In one possible embodiment of the method, the at least one further sensor assembly is an ambient light sensor and/or the sensor of a head-up display. The radiation receiver of an ambient light sensor, a head-up display sensor for example, or similar sensor assemblies, may be used to detect radiation that passes through the window surface. With such a sensor system, it is possible to detect the intensity of the light incident on the motor vehicle, and in the case of the sensor for a head-up display the brightness of the projection of the head-up display can also be controlled by this means.

In one possible embodiment of the method, the sensor assembly additionally detects at least one radiation measurement value of a radiation signal for the window surface in the dry and clean state, this radiation measurement value is stored in a data storage device to serve as a reference value, at least one further radiation measurement value is recorded with the sensor assembly with the window surface in the dry state, the further radiation measurement value is compared with the reference value, and if a radiation measurement value is obtained that differs from the reference value, this is interpreted to mean that there is a deposit on the window surface. The radiation signal is captured with the window surfaces in the dry state. Whether the window surfaces are in a dry state can be determined for example with the aid of a rain-light sensor. The radiation measurement value recorded with the window surface in the dry state is stored as reference value, in particular in a data storage device such as an onboard computer or the like. In this context, it is assumed that the window surface is in a clean state. A defined dry and clean state of the windscreen may be attained for example after the wipe area has been wiped with the windscreen wipers. The vehicle's window washing system may also be actuated before the windscreen wiper is operated. After the reference value has been recorded, further radiation measurement values may be detected via the sensor assembly with the window surfaces in the dry state. These further radiation measurement values may be captured at defined time intervals, for example. The further radiation measurement values are compared with the stored reference value. The comparison of the measurement values may be carried out for example with a computing unit, such as an onboard computer or the like. In the event of differences between the currently detected radiation measurement value and the reference value, it is concluded that there is a deposit on the respective window surface. In particular, it may be concluded that there are deposits on the window surface if the currently detected radiation measurement value has a lower radiation intensity measurement value than the reference value. A radiation signal passing through the window surfaces is attenuated by the deposit on der window surface. In the case of a radiation signal reflected within the window surface, the deposit on the window surface may cause increased scattering or coupling out of the emitted radiation signal, which in turn leads to a decrease in the received reflected radiation signal compared with the reference value, which was recorded in the clean state. By recording the radiation reference value in the clean state, a sensor system already arranged in the motor vehicle for other purposes is also able to draw a conclusion regarding the presence of deposits on the window surface without the need to provide a sensor system specifically for this purpose. If dirt is detected on the window surface, cleaning of the camera's field of view may be initiated in order to clear the camera's field of view.

In a preferred embodiment of the method, if a current radiation measurement value is found to be lower than the reference value, it is concluded that there is dirt on the window surface. If a currently detected radiation measurement value is decreased compared with the reference value, it is concluded that there is dirt on the outer surface of the window surface.

In a further development of the method, a wiping operation is performed with the windscreen wiping device, and the reference value is detected following the wiping operation. The wipe area may be restored to a clean, defined state by overwiping the wipe area of the window surface. Additionally, a window cleaning operation may also be initiated with the vehicle's window washing system before overwiping with the windscreen wiping device. After the wiping operation, the reference value can be recorded, so it may be assumed that the reference value has been recorded with the window surface in the clean and dry state.

In a further development of the method, the further radiation measurement values are recorded at time intervals and compared with the reference value. The further radiation measurement values for testing for dirt on the respective window surface may be captured at specified time intervals and compared with the reference value in order to detect the presence of dirt in good time.

In a further development of the method, the detected radiation signals have passed through the window surface at least in sections and/or are reflected therein. The radiation signals may be for example ambient light signals that have passed through the window surface, or they are radiation signals emitted by the sensor assembly, reflected in the window surface. The radiation signals have thus passed through the possibly dirty outer surface of the window surface or they have been reflected thereon, and the radiation signals are consequently influenced by the dirt, and the dirt is thus detectable by means of the captured radiation signals.

In a preferred further development of the method, a camera is arranged in the same wipe area as the at least one sensor assembly, and when a dirt deposit is detected by the optical sensor assembly, a cleaning process of the camera's field of view is initiated. The radiation receiver of the sensor assembly is preferably arranged in spatial proximity to the camera's field of view. Both the radiation receiver of the sensor assembly and the camera's field of view are arranged in the wipe area of the windscreen wiping device. If a dirt deposit is found by the sensor assembly, a cleaning of the field of view is initiated, by means of the windscreen washing system, for example.

### BRIEF DESCRIPTION OF THE DRAWINGS

In the following text, the method will be explained further with reference to a schematic representation thereof. The schematic illustrations show, in:

FIG. 1: a rain-light sensor on a window surface in the clean state;

FIG. 2: a head-up display sensor a on a window surface in the clean state;

FIG. 3: an ambient light sensor on a window surface in the clean state;

FIG. 4: a rain-light sensor according to FIG. 1 on a window surface in the dirty state;

FIG. 5: a head-up display sensor according to FIG. 2 on a window surface in the dirty state;

FIG. 6: an ambient light sensor according to FIG. 3 on a window surface in the dirty state.

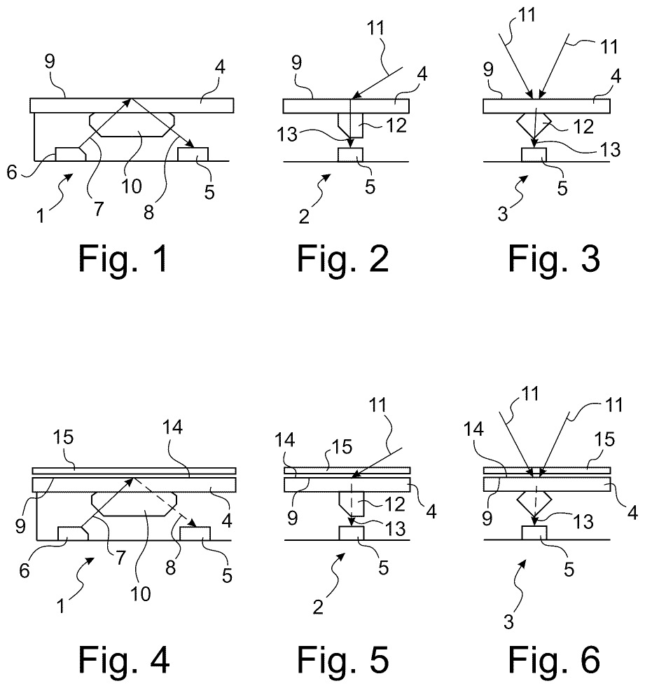

FIG. 1 is a schematic representation of a rain-light sensor 1 on a window surface 4. The rain-light sensor 1 includes a radiation receiver 5 and a radiation emitter 6. A radiation signal 7 is emitted by the radiation emitter 6, coupled into the window surface 4 via an optical element 10, and reflected on the outer boundary surface 9 of the window surface 4. The reflected radiation signal 8 is captured by means of the radiation receiver 5 and is then analysed.

FIG. 2 represents the sensor of a head-up display 2 with a radiation receiver 5. A radiation signal 11 from the area surrounding the motor vehicle incident on the window surface 4 passes through the window surface 4 and is directed via an optical element 12 to a radiation receiver 5. The radiation signal 13 that passed through the window surface 4 is captured by means of the radiation receiver 5 and is then analysed.

FIG. 3 represents a radiation signal 11 from the area surrounding the vehicle that is incident on the window surface 4. The radiation signal 11 passes through the window surface 4 and is directed via an optical element 12 to a radiation receiver 5 of an ambient light sensor 3. The radiation signal 13 that passed through the window surface 4 is captured by means of a radiation receiver 5 and is then analysed.

FIG. 4 is a schematic representation of a rain-light sensor 1 according to FIG. 1 on a window surface 4, wherein a dirt deposit 15 has accumulated on the outside 14 of the window surface 4. More of the emitted radiation signal 7 can be coupled out of the window surface due to the dirt deposit 15, resulting in a reduction in the reflected and received radiation signal 8 compared with the signal when the window surface is in a clean state.

FIG. 5 is a schematic representation of a head-up display 2 according to FIG. 2 on a window surface 4, wherein a dirt deposit 15 has accumulated on the outside 14 of the window surface 4. Radiation signals 11 from the area surrounding the motor vehicle incident on the window surface 4 are attenuated by dirt deposits 15 on the outside 14 with the result that changes in the detected ambient light signals 13 may indicate the presence of dirt on the window surface.

FIG. 6 is a schematic representation of an ambient light sensor 3 according to FIG. 3 on a window surface 4, wherein a dirt deposit 15 has accumulated on the outside 14 of the window surface 4. Radiation signals 11 from the area surrounding the motor vehicle that are incident on the window surface 4 are weakened by dirt deposits 15 on the outside 14, with the result that changes in the detected ambient light signals 13 may indicate the presence of dirt on the window surface.

1. A method for detecting at least a dirt deposit on a window surface of a motor vehicle, wherein at least one sensor assembly, in particular a rain sensor, having at least one radiation receiver and having at least one radiation emitter, is assigned to the window surface of the motor vehicle, wherein at least one windscreen wiping device is also assigned to the window surface to overwipe at least a section of the window surface, and wherein the radiation receiver of the sensor assembly is arranged in the wipe area of the windscreen wiping device, wherein the radiation emitter is designed to emit at least one radiation signal, wherein the radiation signal is coupled into the window surface and reflected therein on a boundary surface with the environment surrounding the vehicle, and wherein at least one radiation measurement value of the reflected radiation signal is detected by means of the radiation receiver, wherein when an increased amount of reflected radiation is coupled out of the window surface, this is interpreted to indicate a deposit on the window surface, and wherein overwiping of the window surface by the windscreen wiping device is initiated, wherein at least one further radiation measurement value of the reflected radiation is detected after the overwiping with the windscreen wiping device, wherein the radiation measurement value of reflected radiation recorded after the overwiping is compared with the radiation measurement value of reflected radiation detected before overwiping, and wherein if the difference between the radiation measurement values before and after overwiping is small enough, it is interpreted to indicate that there is dirt on the window surface.

2. The method according to claim 1, wherein, if the difference between the radiation measurement values of the reflected radiation before and after overwiping falls below a predetermined threshold value, this is interpreted to indicate that there is dirt on the window surface.

3. The method according to claim 1, wherein maximum values for the radiation measurement values of the reflected radiation are detected, at least one filtered maximum value is formed from the maximum values for the radiation measurement values, and the radiation measurement value detected after overwiping is evaluated on the basis of the filtered maximum value of the radiation measurement values.

4. The method according to claim 1, wherein further radiation measurement values are captured by means of at least one further sensor assembly, that the at least one sensor assembly is designed to detect at least one radiation signal passing through the window surface, that the further radiation measurement values are recorded at time intervals, that the further radiation measurement values are analysed statistically, and that if it is determined that the further radiation measurement values are generally decreasing over time, they are used to carry out a plausibility check of a detected dirt deposit.

5. The method according to claim 4, wherein the at least one further sensor assembly is an ambient light sensor and/or the sensor of a head-up display.

6. The method according to claim 1, wherein the at least one sensor assembly additionally detects at least one radiation measurement value of a radiation signal for the window surface in the dry and clean state, that the radiation measurement value is stored in a data storage device as a reference value, that at least one further radiation measurement value is recorded by the sensor assembly with the window surface in the dry state, that the further radiation measurement value is compared with the reference value, and that if a radiation measurement value is obtained that differs from the reference value, this is interpreted to mean that there is a deposit on the window surface.

7. The method according to claim 6, wherein, if a currently measured radiation measurement value is smaller than the reference value, it is concluded that there is a dirt deposit on the window surface.

8The method according to claim 6, wherein a wiping operation is carried out with the windscreen wiping device, and the reference value is captured following the wiping operation.

9. The method according to claim 6, wherein the further radiation measurement values are recorded at time intervals and are compared with the reference value.

10. The method according to claim 1, wherein a camera is arranged in the same wipe area as the at least one sensor assembly, and that when a dirt deposit (15) is detected by the optical sensor assembly, a cleaning process of the camera's field of view is initiated.
